(19) United States
(12) Patent Application Publication
(10) Pub. No.: US 2015/0234822 A1
(43) Pub. Date: Aug. 20, 2015

(54) QUERY METHOD TO IDENTIFY RELEVANT INTERESTS USING MODIFIED NATURAL LANGUAGE

(71) Applicant: DAXTecnologia da informação Ltda, Sao Paulo (BR)

(72) Inventors: André Galassi Gargalhone, Sao Paulo (BR); Dominic Charles MacDermot, Sao Paulo (BR); Wladimir Fernandes de Rezende, Uberlandia - Minas Gerais (BR); Éderson Machado de Lima, Uberlandia - Minas Gerais (BR); Edson Simão Júnior, Uberlandia - Minas Gerais (BR); Carlos Otávio Lara Pinheiro, Uberlandia - Minas Gerais (BR)

(73) Assignee: DAXTecnologia da informação Ltda, Sao Paulo (BR)

(21) Appl. No.: 14/181,000

(22) Filed: Feb. 14, 2014

(51) Int. Cl. G06F 17/30

(52) U.S. Cl. CPC G06F 17/3043; G06F 17/30864

(57) ABSTRACT

A method for electronically executing a query using an electronic device having a display and an input device, that is connected to a computer readable storage medium and connected through a network to a database, such as the Internet. A natural-language-text query string is entered and presented on the display. Relevant query words are selected from among the potential query words of the query string. The relevant query words are encoded on the storage medium and the database is searched to identify registered interests in the relevant query words. A query report is then formed and presented on the display. Optional search string modification steps are taken to further refine the search query in a dynamic fashion.

### FIELD OF THE DISCLOSURE

The present disclosure relates to searching for opportunities across systems, networks and organizations, and more specifically to electronic queries using modified natural language strings of text.

### BACKGROUND OF THE DISCLOSURE

The rapid expansion of the Internet and its availability to users has been well documented. For instance, in late 1995 less than one percent of the world's population had access to the Internet, whereas in 2013 that portion had grown to approximately forty percent.

This dynamic creates innumerable opportunities, previously unavailable, at the local and global level for individuals or groups having approximate or matching interests. It has long been desired by many to be able to effectively identify and make use of these opportunities. However, the immensity of this environment creates difficulties for the combination of interests and the consequent generation and exploitation of opportunities.

To this end there are many resources and solutions, taking various forms, which aim to connect individuals with approximate or shared interests over networks such as the Internet. Some websites connect groups with specific interests, for instance in legacy computing technologies. Other systems categorize people or items according to various traits. For example, numerous online dating services categorize individuals according to their personal characteristics and interests after they complete a questionnaire, and then seek to match two compatible individuals. Such operation is typical of a ‘match’ type system or website. Other systems may seek to use categorization for trade or business activities, for example by allowing users to share business opportunities or expose products in specific categories. Some such platforms may allow users to create “alerts” which notify the user when products bearing certain key words associated with specific categories are entered into the system.

Social media platforms, such as FACEBOOK by Facebook, Inc., LINKEDIN by LinkedIn Corporation and TWITTER by Twitter, Inc., have also expanded at an exponential pace. Forums and other outlets allow the congregation of individuals and organizations having similar interests.

Various query methodologies have been developed to allow users to search the expansive and otherwise largely unorganized array of information and connections. For instance, U.S. Pat. No. 8,555,182 discloses a graphical user interface (GUI) for searching in which a user can graphically reposition search terms so as to indicate that they have a higher or lower relevance than other search terms of the same search string. U.S. Pat. No. 8,555,182 is incorporated by reference herein in its entirety.

However, many previously existing systems often require the prior categorization of interests in order to facilitate the identification of opportunities. It remains difficult in many instances to attain the maximum benefits of the enormous potential of interlinking environments. Existing query methods also do not allow dynamic refinement so as to allow users to more readily locate the desired opportunities.

The subject matter of the present disclosure is directed to overcoming, or at least reducing the effects of, one or more of the problems set forth above.

### BRIEF SUMMARY

Disclosed is a method for effective querying that allows a user to search for opportunities using natural language. In an embodiment, a user enters a natural language text string, which is presented on the display of an electronic device as a set of potential query words. The user is able to identify particular query words as being relevant or irrelevant. The Internet, or any applicable database, is searched for relevant interests, defined as those containing some portion of the selected relevant query words. A query report containing relevant interests is displayed on the electronic device. In certain embodiments, additional words are suggested to the user for use as relevant query words, creating a dynamic query system that is better able to resolve to the desired opportunities.

Users thus may seek out opportunities and interests irrespective of geographic boundaries and without requiring interests to be previously categorized. Users are able to effectively employ natural language, as opposed to less intuitive search “language” such as the use of Boolean operators.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 depicts a system according to an embodiment for use in executing the disclosed query method.

FIG. 2 is a flow chart diagram of an embodiment.

FIG. 3 is a flow chart diagram of the embodiment method of FIG. 2 having additional steps.

FIGS. 4A-C are illustrations of the screens presented to a user on the display of an electronic device during various steps in an embodiment.

FIG. 5 is a flowchart of an embodiment.

FIGS. 6A-K are illustrations of the screens presented to a user on the display of an electronic device during various steps in an embodiment.

Like reference numbers and designations in the various drawings indicate like elements.

### DETAILED DESCRIPTION

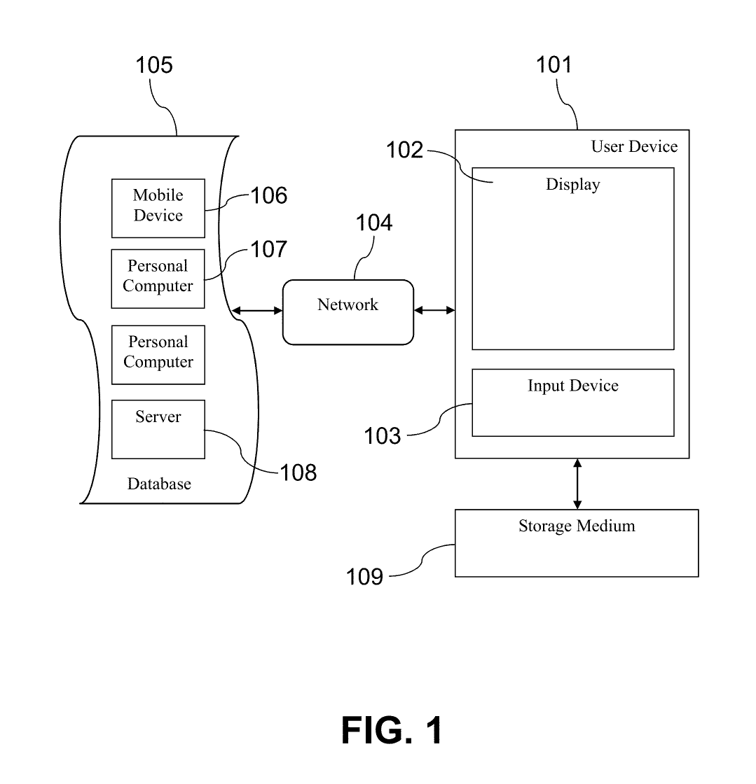

FIG. 1 schematically illustrates an embodiment system for execution of the disclosed method. User Device 101 has display 102 and input device 103. Display 102 may be the screen of any suitable electronic device, such as the screen of a computer, smartphone, tablet computer, or any other electronic device connectable to a network or the Internet. Similarly, input device 103 may be any suitable input device, such as a computer mouse, touch screen, keyboard, microphone, or combination thereof. Network 104 connects user device 101 to database 105. In the embodiment, database 105 includes at least mobile device 106, personal computers 107 and server 108. The term “database” as used in this application refers broadly to any electronic source of information, preferably the Internet, which may be searched for the query purposes described. Thus, the term database as used in the present disclosure is not limited to electronic systems dedicated to the organized storage of information. Elements of the database may enter and exit the system, for instance when a device is disconnected from the Internet. Database should be understood to encompass such elements as websites, forums, and various electronic social media platforms.

User device 101 is further connected to storage medium 109. Storage medium 109 may be any suitable computer readable non-transitory storage medium, many of which will be apparent to those of skill in the art to which the present application pertains. For example, suitable mediums may include traditional computer hard drives, solid state drives, optical disks, etc. Furthermore, the storage medium may be integral to the user device or entail multiple digital storage segments which optionally may be spread across separate physical devices.

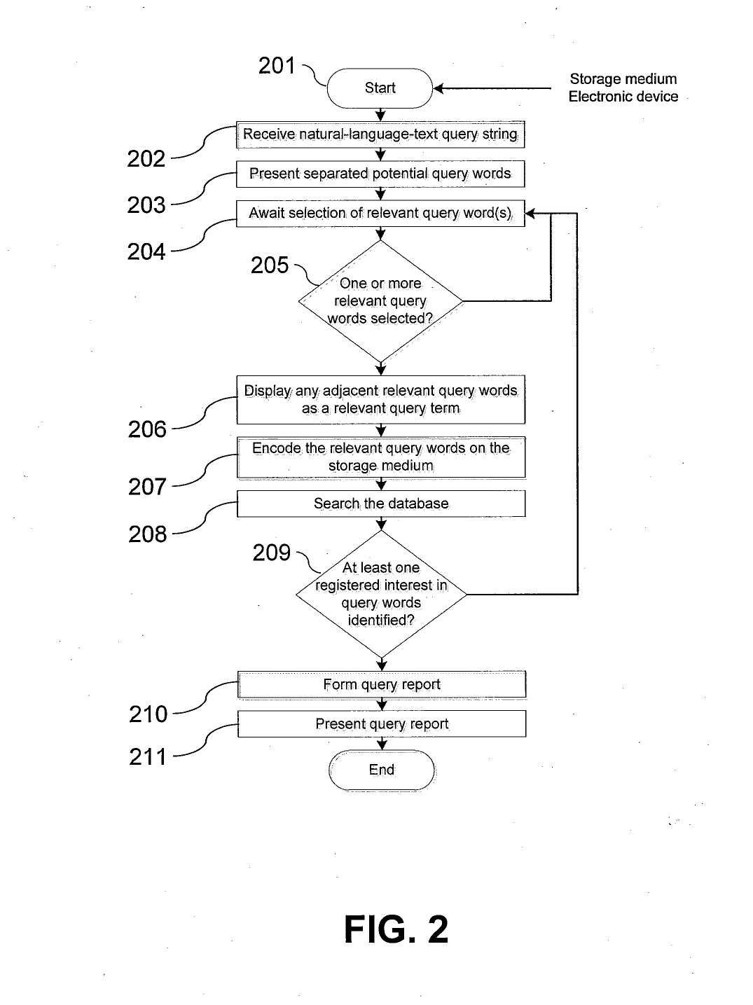

FIG. 2 is a flow chart diagram of an embodiment. In step 201, a computer readable non-transitory storage medium and an electronic device having a display and an input device are provided. The electronic device is connected to a database through a network. In step 202, a natural-language-text query is received via the input device, containing a plurality of potential query words. In step 203, the potential query words are presented on the display of the electronic device. In steps 204-205, the electronic device awaits user input that at least one of the potential query words is a relevant query word. Once at least one potential query word is selected as a relevant query word, the method moves to step 206. In optional step 206, if adjacent potential query words are selected as being relevant query words, such relevant query words are considered a relevant search term. Relevant search terms can aid in more quickly resolving to the desired opportunities. For instance, if a user is searching for a “red coupe” it is desirable to return results specifically mentioning a “red coupe” as opposed to a result containing “coupe” and “red” separately.

In step 207, the relevant query words are encoded on the storage medium. In step 208, the database is searched to determine whether there is a registered interest in at least one of the relevant query words. For instance, a website forum may have a post that contains the relevant query words because it offers the sought-after opportunity. In step 209, if no registered interest is identified, the process returns to step 204, and the additional selection of a new relevant query word is awaited. In step 210, a query report is formed containing at least one of the identified registered interests. In step 211, the query report is presented on the display of the electronic device. There are many formats which may be used for this purpose. For instance, excerpts from the registered interest may be included in the query report, so that a user can easily determine whether the registered interest presents the sought opportunity, or whether it is extraneous.

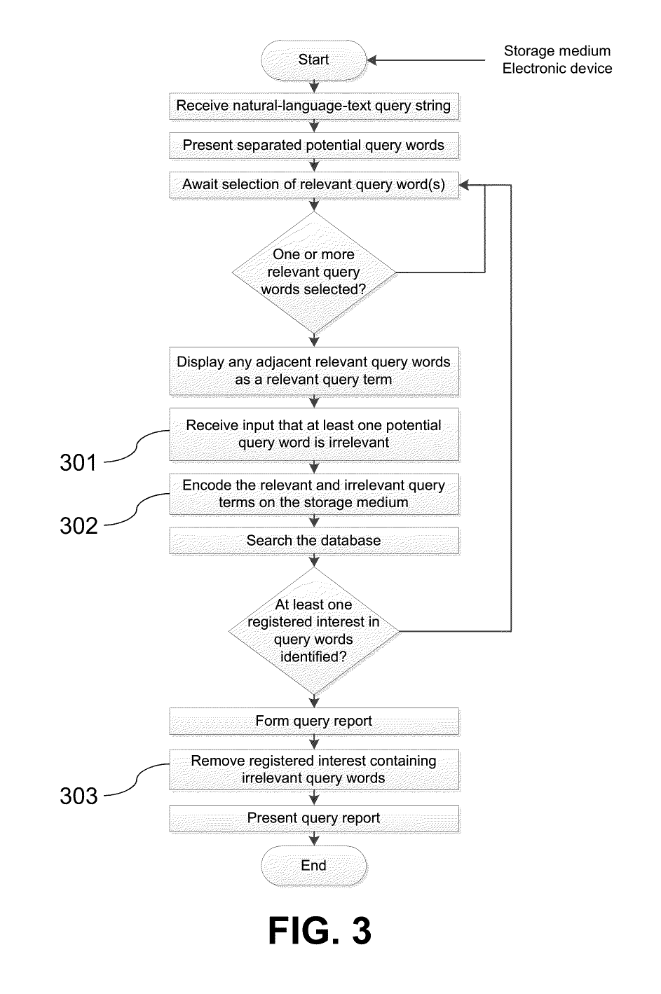

FIG. 3 is a flowchart diagram of an embodiment that is in many respects similar to that of FIG. 2. However, in step 301, input is received that a potential query word(s) is irrelevant. In step 302, this information is encoded on the storage medium. After registered interests are identified, results containing the irrelevant word are removed. Thereby, the user may cull the search results to eliminate extraneous results prior to viewing the query report.

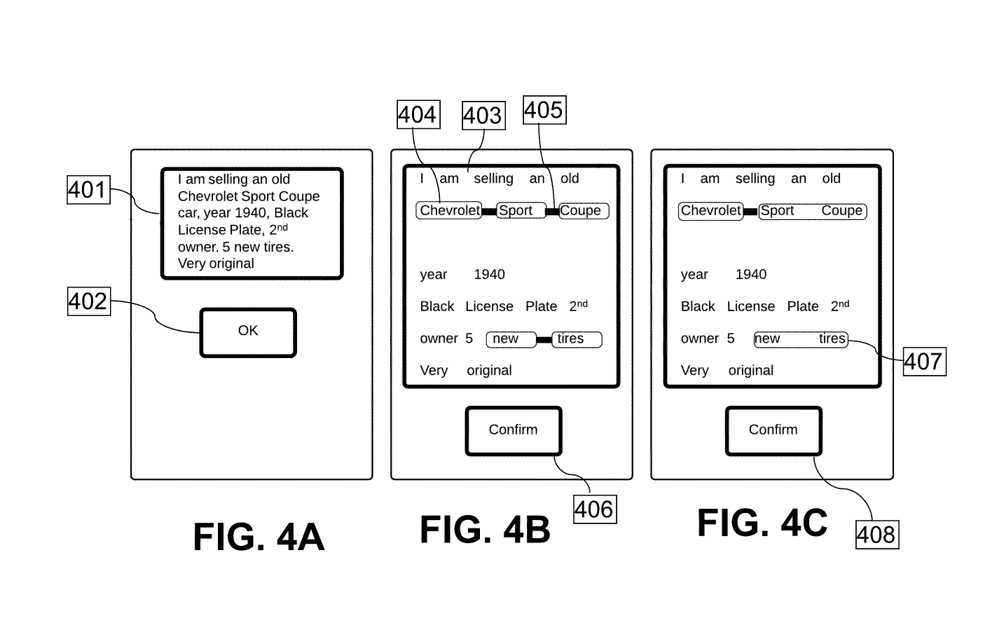

FIGS. 4A-C are illustrations of consecutive screens presented on the display of an electronic device as used in performing the disclosed method. In FIG. 4A, a user enters, via an input device, a natural-language-text query string into text entry box 401. When the user is done entering text, the user selects “OK” button 402 to proceed. In FIG. 4B, the user is presented with the potential query words of the input text string, each separated from adjacent potential query words by spacing distance 403. The spacing distance, in part, allows the user to intuitively evaluate the relevance of the potential query words, thus facilitating more fluid and effective searching. The user then selects several potential query words as being relevant query words 404. In the example, “Chevrolet,” “Sport,” “Coupe,” “new,” and “tires” have been selected as relevant query words. As illustrated, the relevant query words are identified for the user, in the embodiment by a rounded-edge rectangle. Optionally, a user is able to join adjacent query words to create a relevant search term, which is indicated by indicator 405, in this case a joining bar. For instance, search term 406 is the phrase “new tires.”

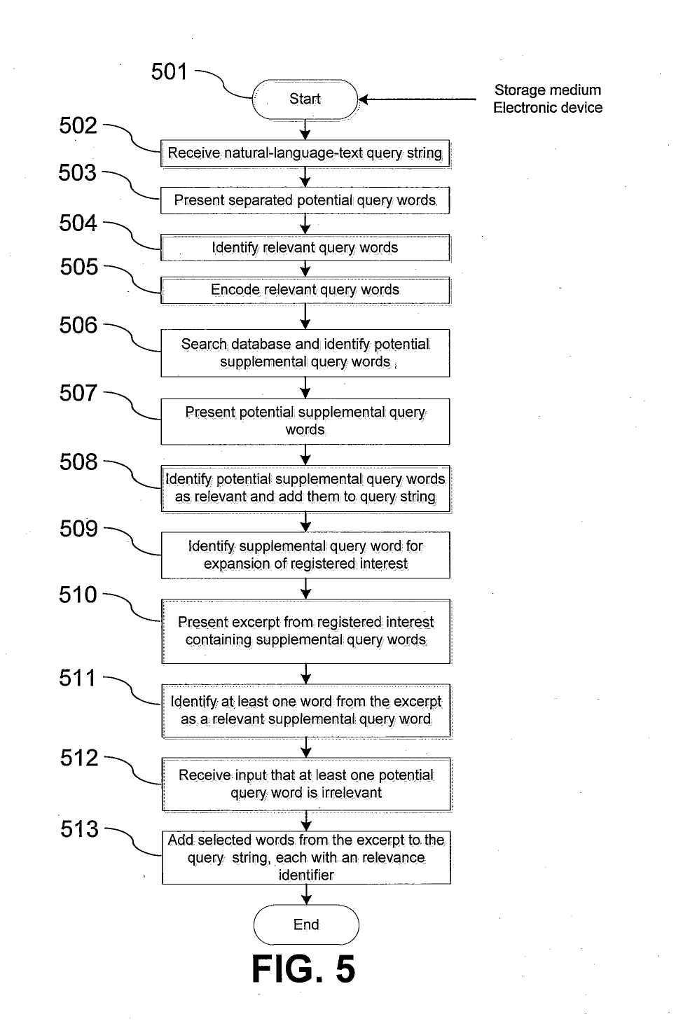

FIG. 5 is a flowchart of an embodiment method. In step 501, a computer-readable non-transient storage medium and an electronic device having a display and an input device are provided. The electronic device is connected to a database through a network. In step 503, a user inputs a natural-language-text query string containing a plurality of potential query words via the input device, which is presented to the user on the display. In step 504, the user identifies at least one of the potential query words as being a relevant query word, meaning the user believes it is relevant to the interests or opportunities for which the user is searching. In step 505, the provided relevant query words are encoded on the storage medium. The database is then searched in step 506 to identify whether there is a registered interest in at least one of the relevant query words. Optionally, if no relevant interest is identified the process can return to the step of allowing the user to select relevant query words from the list of potential query words. From the registered interest, supplemental query words are identified, preferably based on other users' previous expression of an interest in one or more of the relevant query words.

In step 507, these potential supplemental query words are presented on the display of the electronic device. The user can then select at least one of the supplemental query words as being a relevant supplemental query word. Preferably, the relevant supplemental query word is then treated in the same manner as a relevant query word, and can be visually repositioned on the display to accompany the relevant query words. In step 508, the user selects a particular supplemental query word causing an excerpt from the interest from which it was pulled to be displayed. In step 508, an excerpt from the interest is presented on the display, having a plurality of excerpt words. In step 511, from the excerpt text the user selects an excerpt word that is to be considered a relevant excerpt word. Optionally, the user can vary the size of the excerpt to view more or less text, thus accommodating, for instance, varying screen sizes among electronic devices. In step 512, the user selects at least one excerpt word as being irrelevant. For instance, the user could select “in” as not being material to the interest or opportunity for which they are searching. In step 513, the selected words from the excerpt are added to the query string, preferably with indicators that they are either relevant or irrelevant. Thus the final query string containing the relevant query words, relevant supplemental query words and relevant excerpt words is formed.

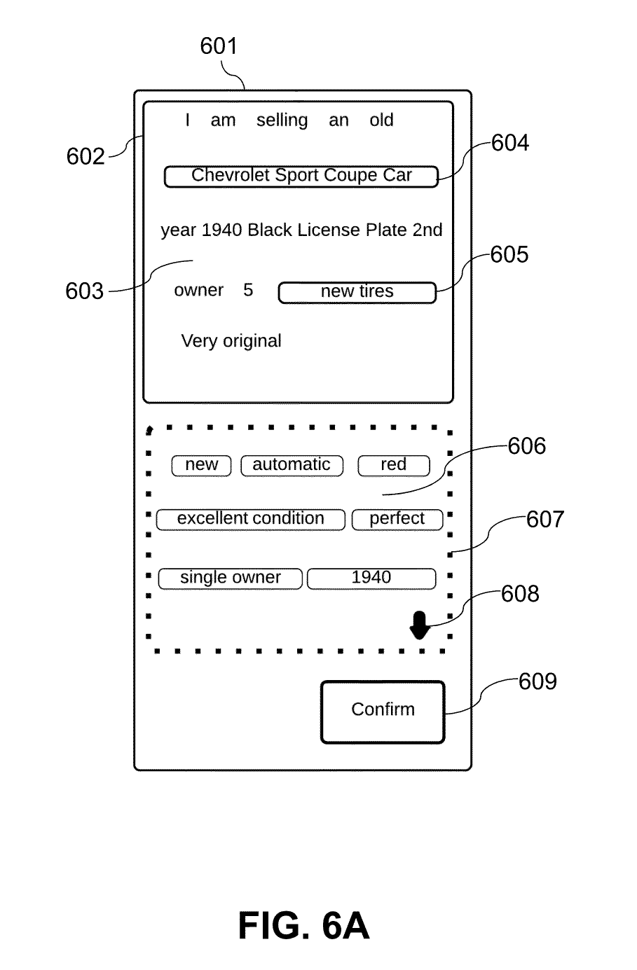

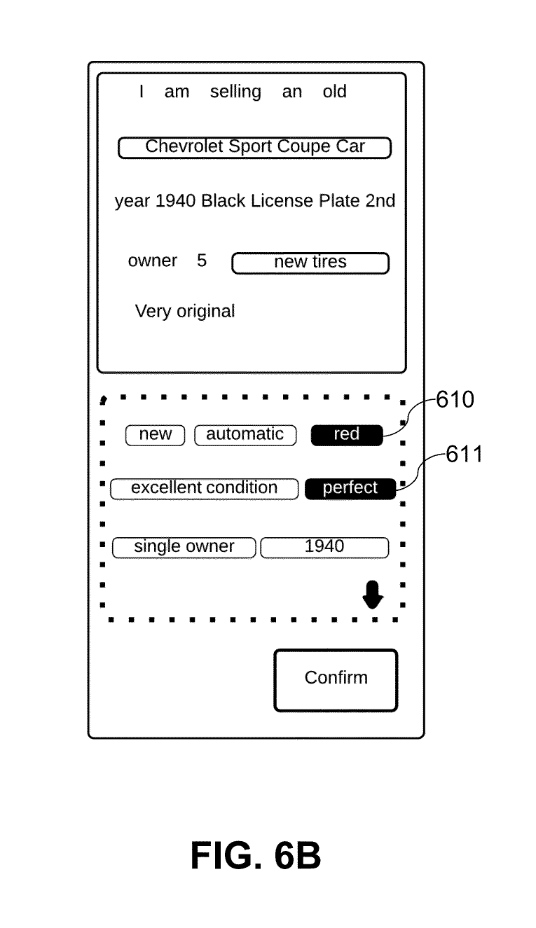

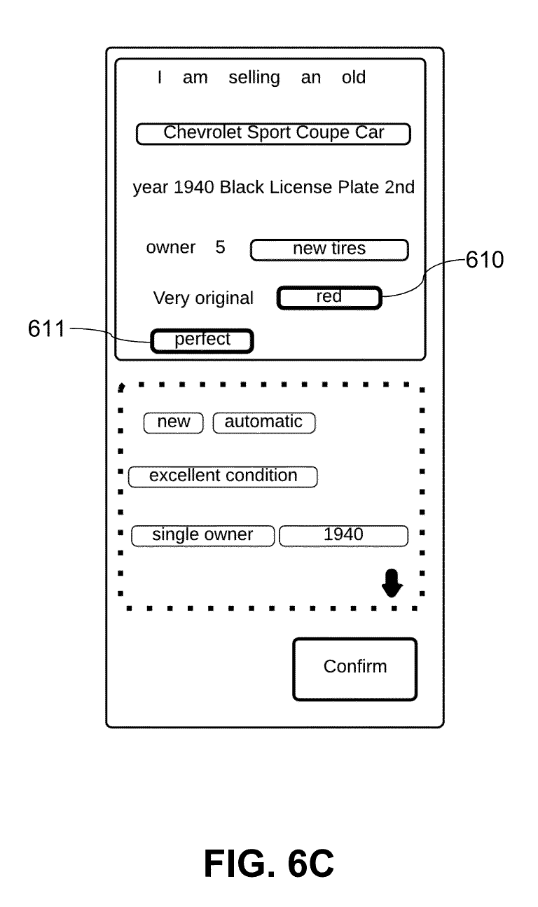

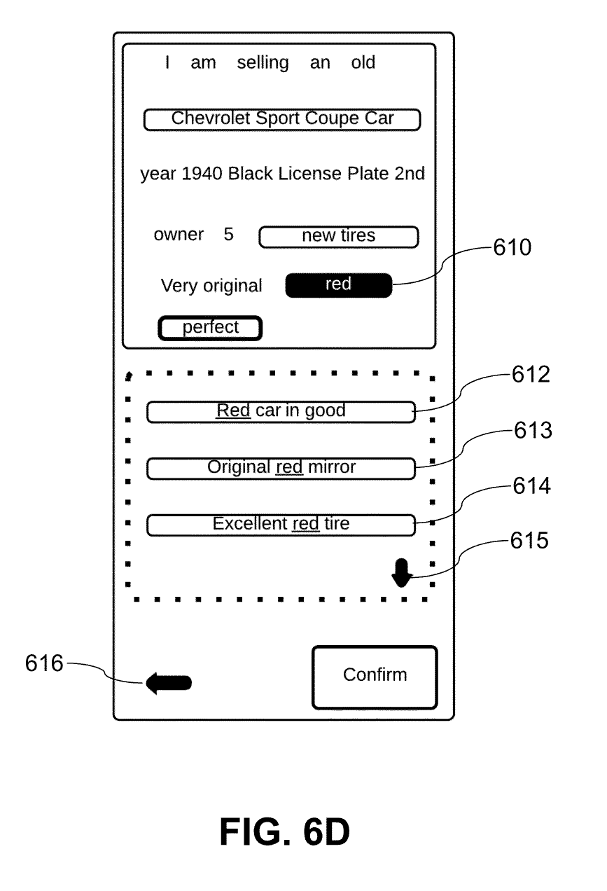

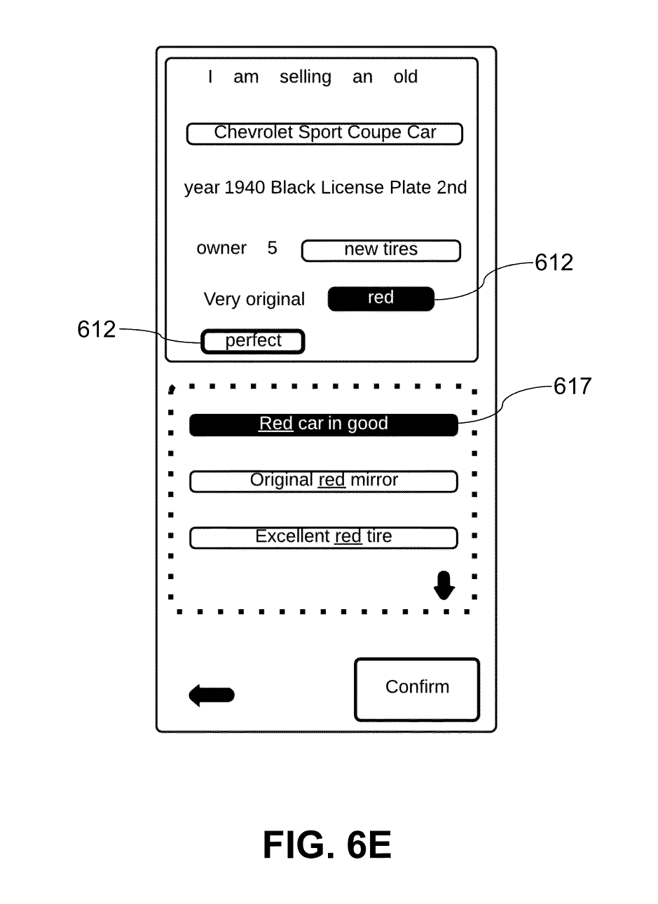

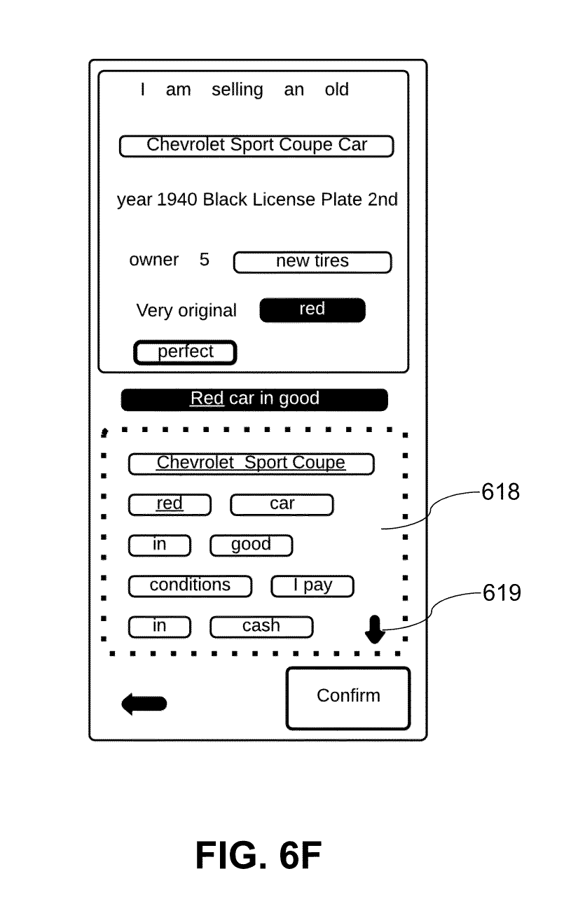

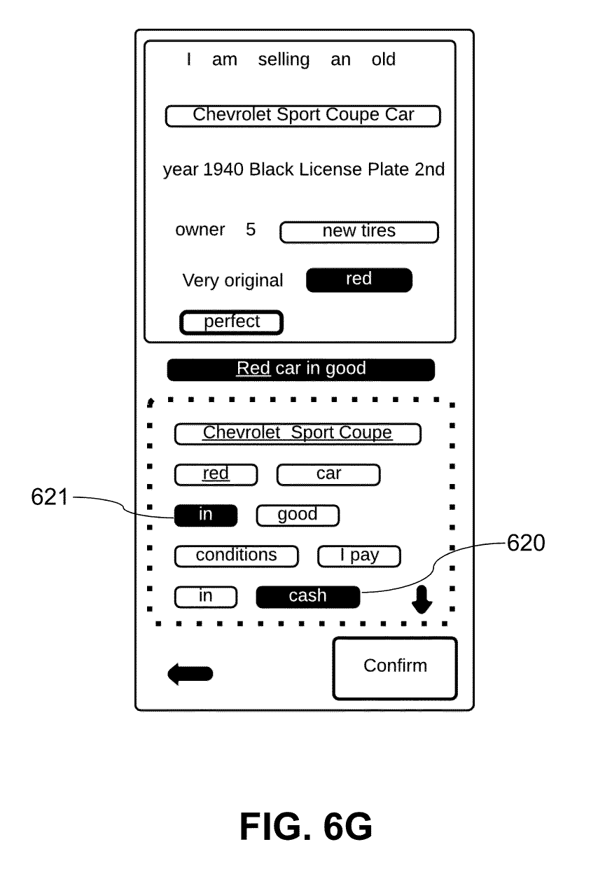

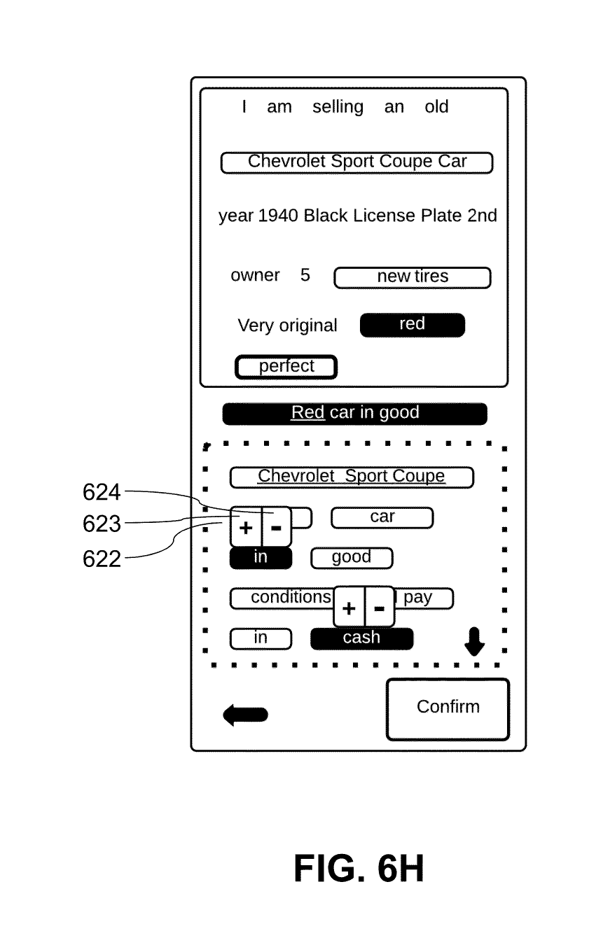

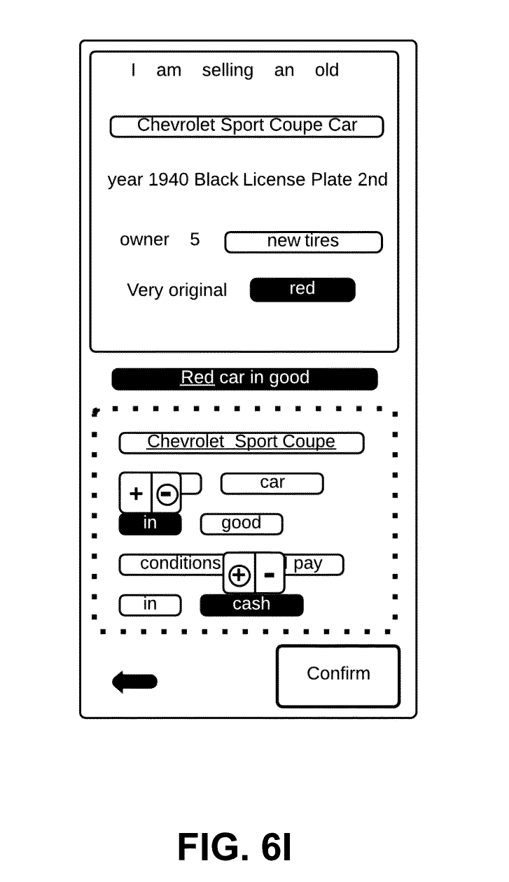

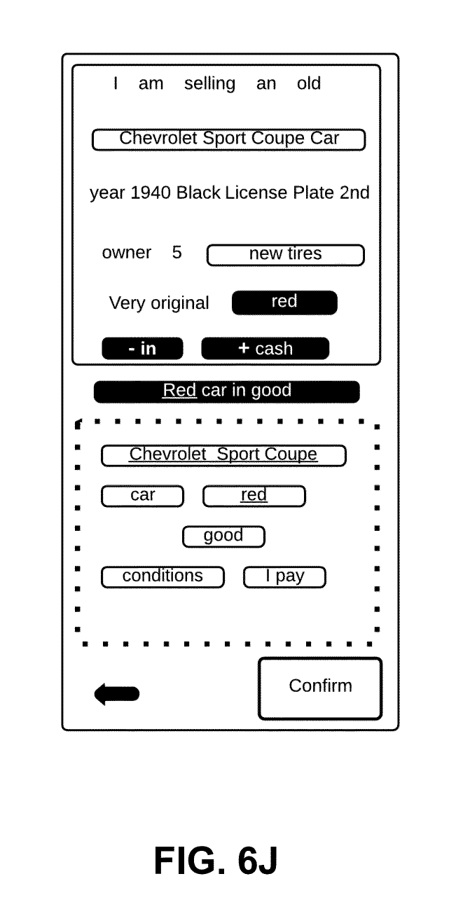

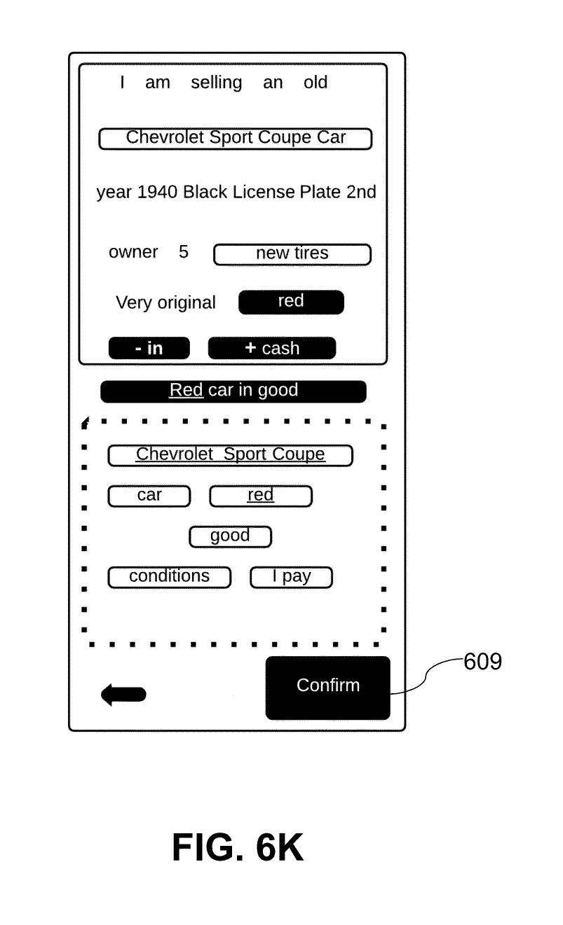

FIGS. 6A-K are illustrations of a emblematic series of screens showing the execution of an embodiment similar in many respects to that disclosed in FIG. 5. The images shown in FIGS. 6A-K are as they would be presented to a user on the display of an electronic device. Generally, navigation among different screens and their appearance can take many forms which will be apparent to those of skill in the art to which the present application pertains. In general screen 601 is text field 602, in which is presented natural-language-text query string 603 containing words that are ready for selection by a user. In the example, first relevant query term 604 contains the words “Chevrolet Sport Coupe Car” and second relevant query term 605 contains the words “new tires.” The system has searched the database and identified potential supplemental query words 606 that are related to the relevant query terms previously identified by the user (query term 604 and query term 605). Preferably, the potential supplemental query words are identified based on their having been previously identified by other users as related to the relevant query words. In the example, included in supplemental query words 606 are “new,” “automatic,” “red,” “excellent condition,” “perfect,” “single owner,” and “1940.” Supplemental query words 606 are displayed in supplement field 607. Drop down button 608 indicates to the user that there are additional supplemental query words available for the user to review as desired. Confirmation button 609 is selectable by the user and can be used to conclude the supplemental process.

In FIG. 6B it can be seen that the user has selected first relevant supplemental query word 610, which in this case is “red,” and also second relevant supplemental query word 611, which in this case is “perfect.” The system treats these supplemental words as if they were original relevant query words (such as “Chevrolet”) as depicted by the screen in FIG. 6C. As depicted in FIG. 6D, further selection of first supplemental query word 610 causes the display of sentences 612, 613 and 614. in which other users also had marked the same word as relevant. Drop down button 615 indicates to the user that there are other sentences available for inspection. Back button 616, when selected, allows the user to return to the previous screen.

In FIG. 6E, the selection of first sentence fragment 617 causes first sentence fragment 617 to be highlighted on the presented screen. As depicted in FIG. 6F, the user is then presented with excerpt 618, in which first sentence fragment 617 was contained. Drop down button 619 indicates to the user that there are additional words that can be displayed. As depicted in FIG. 6G, from excerpt 618 the user selects first word 620, in this case “cash,” and second word 621, in this case “in.” As depicted in FIG. 6H, presented to the user next to each selected word is set of indicators 622 having a first indicator 623, being a “+” symbol, and a second indicator 624, being a “−” symbol. In the example, the user selects the second indicator “−” next to the word “in,” indicating that this word is irrelevant. The user also selects the “+” symbol next to the word “cash,” indicating that it is a relevant word. Figure I depicts the visual confirmation provided to the user that first word 620 and second word 621 have been appropriately categorized as relevant and irrelevant, respectively. As depicted in FIG. 6J, first word 620 and second word 621, as well as their respective indicators, are added to text field 609. As depicted in FIG. 6K, selection of confirm button 604 concludes the process of creating the search query.

The aforementioned method is thus a dynamic method by which search strings of high quality and accuracy can be rapidly developed by a user.

The disclosed method and system present several advantages over previously existing systems. For instance, prior categorization of interests is rendered unnecessary to effect the matching of shared interests and identification of desired opportunities. Repeated searches are thus avoided.

One or more embodiments of the present invention have been described. Nevertheless, it will be understood that various modifications may be made without departing from the spirit and scope of the invention. Accordingly, other embodiments are within the scope of the following claims.

What is claimed:

1. A method for electronically executing a query, comprising the steps of:
providing a computer readable non-transitory storage medium;
providing an electronic device having a display and an input device, the electronic device being connected to a database through a network;
receiving via the input device a natural-language-text query string containing a plurality of potential query words;
presenting on the display the potential query words;
receiving input via the input device that at least one of the potential query words is a relevant query word;
encoding the relevant query words on the storage medium;
searching the database to determine whether there is a registered interest in at least one of the relevant query words;
upon identifying at least one registered interest, forming a query report containing at least one registered interest;
presenting the query report on the display.

2. The method of claim 1, wherein during the step of presenting the potential query words, presenting each potential query word as being separated from any adjacent potential query word by a separation distance;
receiving input via the input device that two adjacent potential query words together form a query term; and

3. The method of claim 2, wherein during the step of searching the database, modifying the search so that only interests that contain at least one query term are identified as relevant interests.

4. The method of claim 1, further comprising:
receiving input via the input device that at least one of the query words is an irrelevant query word.

5. The method of claim 4, further comprising:
after the step of forming a query report, removing from the query report any registered interest containing an irrelevant query word.

6. The method of claim 1, further comprising:
at the completion of the step of searching the database, if no registered interest is identified, returning to the step of receiving input via the input device that a potential query word is a relevant query word.

7. The method of claim 1, further comprising:
Identifying in at least one registered interest at least one supplemental query word related to at least one of the relevant query words;
presenting on the display an indicator that supplemental query words are available for at least one relevant query word;
receiving a first supplemental input via the input device that supplemental query words for at least one selected relevant query word should be displayed;
displaying the supplemental query words associated with the selected relevant query word;
receiving a second supplemental input via the input device that at least one supplemental query word is a supplemental relevant query word;
encoding the supplemental relevant query word on the storage medium;
further searching the database to identify whether there is a registered interest in at least one of the relevant query words and at least one supplemental relevant query word;
upon identifying at least one registered interest containing at least one relevant query word and at least one supplemental relevant query word, updating the query report to contain at least one such registered interest;
presenting the updated query report on the display.

8. The method of claim 7, further comprising:
receiving input that at least one of the supplemental query words is an irrelevant supplemental query word; and
removing from the query report any registered interest containing at least one irrelevant supplemental query word.

9. A method for a refining electronically-executed query, comprising the steps of:
providing a computer readable non-transitory storage medium;
providing an electronic device having a display and an input device, the electronic device being connected to a database through a network;
receiving via the input device a natural-language-text query string containing a plurality of potential query words;
presenting on the display the potential query words;
identifying through the input device that at least one of the potential query words is a relevant query word;
encoding the relevant query words on the storage medium;
searching the database to determine whether there is a registered interest in at least one of the relevant query words;
upon identifying at least one registered interest, presenting on the display at least one potential supplemental query word;
identifying at least one potential supplemental query word as a relevant supplemental query word;
presenting on the display an excerpt having a plurality of excerpt words from a particular registered interest related to a particular relevant supplemental query word;
identifying through the input device that at least one excerpt word is a relevant excerpt word; and
forming a final query string containing the relevant query words, relevant supplemental query words and relevant excerpt words.

10. A system for electronic execution of a query, comprising:
a computer readable non-transitory storage medium;
an electronic device having a display and an input device, the electronic device being connected to a database through a network;
said input device configured to receive a natural-language-text query string containing a plurality of potential query words and input that at least one of the potential query words is a relevant query word;
said electronic device configured to encode the relevant query words on the storage medium, and further configured to search the database to identify registered interest in the relevant query words and form a query report containing at least one registered interest; and
said device effective to present the query report.

11. The system of claim 10, wherein the display is configured to present the potential query words, each separated from any adjacent potential query word by a separation distance;
receiving input via the input device that two adjacent potential query words together form a query term; and

12. The system of claim 11, wherein the electronic device is further configured to search so as to only identify as relevant interests those interests having at least one query term.

13. The system of claim 10, wherein said input device is further configured to receive input that one of the potential query words is an irrelevant query word.

14. The system of claim 13, wherein the electronic device is further configured to remove from the query report any relevant interest containing an irrelevant query word.
